(19) United States
(12) Patent Application Publication
(10) Pub. No.: US 2004/0088697 A1
(43) Pub. Date: May 6, 2004

(54) Software loading system and method

(76) Inventors: Jeffrey D. Schwartz, Loveland, CO (US); Jennifer J. Thayer, Greeley, CO (US)

Correspondence Address: HEWLETT-PACKARD COMPANY, Intellectual Property Administration, P. O. Box 272400, Fort Collins, CO, 80527-2400, US

(21) Appl. No.: 10/284,648

(22) Filed: Oct. 31, 2002

(51) Int. Cl. G06F 9/44; G06F 15/177

(52) U.S. Cl. 717/174; 713/2; 717/168

(57) ABSTRACT

A software loading method comprises providing a first software package on one of a plurality of primary partitions in a storage medium. The first software package comprises a first boot loader module, an installer system, and a secure operating system. The installer system is operable to install a second software package, which comprises a second boot loader module, a primary operating system operable to be executed by a processor, and an appliance application. The method also comprises automatically installing the second software package on a second of the plurality of primary partitions.

### TECHNICAL FIELD OF THE INVENTION

The present invention relates generally to the field of computer systems and, more particularly, to a software loading system and method.

### BACKGROUND OF THE INVENTION

Computer systems have become a pervasive mechanism for computing, word processing, accessing global computer networks such as the Internet, etc. Popular computer systems such as personal computers (PCs) are often shipped to users with software pre-loaded. In many cases, the users rely on automated help applications and online support to use their PCs and to troubleshoot when problems occur.

Unfortunately, in many cases, computers such as PCs must be returned to manufacturers due to software failures. Often, these software failures result from user errors such as, for example, damage incurred by incorrectly loaded applications that may overwrite memory or interfere with pre-loaded software. In this scenario, these software applications place the unit in a state in which a service representative cannot troubleshoot it. Thus, in many cases, the unit must be physically returned to the manufacturer, and often replaced by the manufacturer at a significant cost.

In other cases, applications such as boot loaders may be used to start operating systems (OSs). If the OS is altered by inadvertent or other access, the PC may not properly operate. Moreover, if these boot loaders are similarly altered, the OS may not be invoked. Furthermore, most PCs require updates to operate or to maintain loaded software. Alteration of these installer systems used to load OSs and applications presents significant problems. Moreover, altered installer systems may not be able to access a medium such as a compact disc (CD) that may be included with the unit as an external booting mechanism.

Furthermore, in many cases, separate media, such as CDs, that contain a boot loader, an installer system, an OS, and/or additional applications is usually included with the unit, but may be misplaced or forged. Where an unauthorized CD is used to boot the system, the unit may be unauthorizedly accessed. Where the CD has been misplaced and cannot be used to boot the unit, the user may be denied access to the unit.

### SUMMARY OF THE INVENTION

An embodiment of a software loading method comprises providing a first software package on one of a plurality of primary partitions in a storage medium. The first software package comprises a first boot loader module, an installer system, and a secure operating system. The installer system is operable to install a second software package, which comprises a second boot loader module, a primary operating system, and an appliance application. The method also comprises automatically installing the second software package on a second of the plurality of primary partitions.

An embodiment of a software loading application comprises a computer-readable storage medium comprising a plurality of primary partitions and a first software package resident on one of the primary plurality of partitions. The first software package comprises a first boot loader module, an installer system, and a secure operating system. The installer system is operable to automatically install a second software package on a second of the plurality of primary partitions. The second software package comprises a second boot loader module, a primary operating system operable to be executed by a processor, and an appliance application.

Another embodiment of a software loading method comprises providing a first software package on one of a plurality of primary partitions in a storage medium operatively associated with an appliance. The first software package comprises a first boot loader module, an installer system, and a secure operating system. The installer system is operable to install a second software package, which comprises a second boot loader module, a primary operating system, and an appliance application. The method also comprises automatically installing the second software package on a second of the plurality of primary partitions.

An embodiment of a software loading system comprises a storage medium comprising a plurality of primary partitions and an appliance operatively associated with the storage medium. The system also comprises a first software package resident on one of the primary plurality of partitions. The first software package comprises a first boot loader module, an installer system, and a secure operating system. The installer system is operable to automatically install a second software package on a second of the plurality of primary partitions. The second software package comprises a second boot loader module, a primary operating system operable to be executed by a processor, and an appliance application.

### BRIEF DESCRIPTION OF THE DRAWINGS

For a more complete understanding of the present invention and the advantages thereof, reference is now made to the following descriptions taken in connection with the accompanying drawings and which:

FIG. 1 is a block diagram of an embodiment of a loading system according to the present invention; and

FIG. 2 is an example of a method that may be used in a boot sequence to load software utilizing teachings of the present invention.

### DETAILED DESCRIPTION OF THE DRAWINGS

From the foregoing, it may be appreciated that a need has arisen for providing a method for loading an independent operating system that may be used to boot an appliance or other processing element. In accordance with the present invention, a software loading system and method are provided that substantially eliminate or reduce disadvantages and problems of conventional systems.

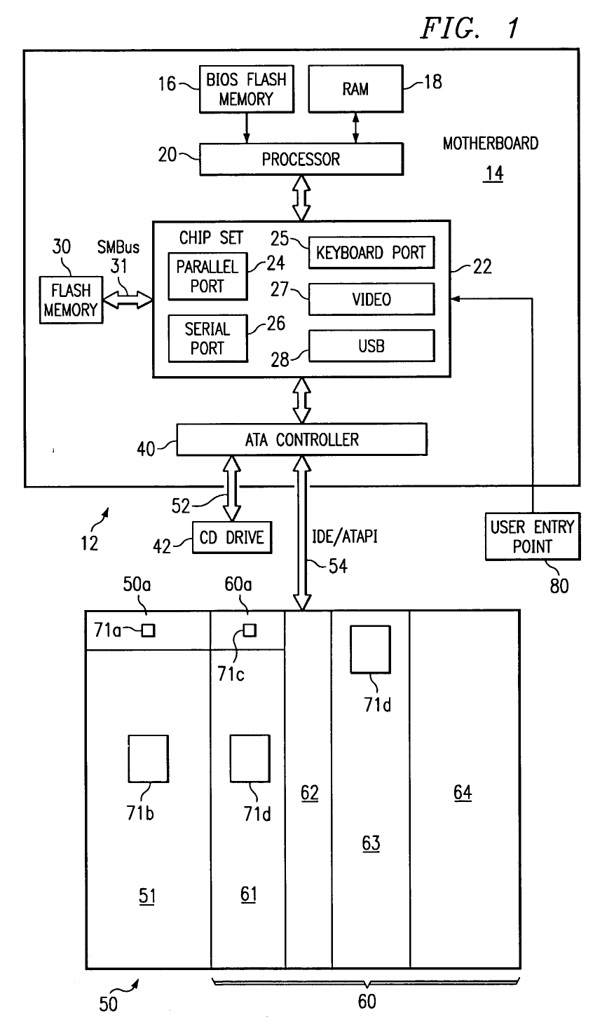

FIG. 1 is a block diagram of an embodiment of a loading system according to the present invention. In the embodiment illustrated in FIG. 1, loading system 10 includes an processing element 12 that has a storage device 50 that, in this embodiment, comprises a plurality of partitions 51 and 60. System 10 is preferably operable to automatically load and install a secure operating system (OS), a boot loader, a primary OS, appliance applications, and updates onto storage device 50 according to the invention. For example, a first boot loader module 71a of first software package 71b inquires whether a second boot loader module 71c from second software package 71d is present in the second partition. If not, first boot loader module 71a starts a secure OS that runs an installer system, which installs the second software package 71d. Second software package 71d includes second boot loader module 71c, a primary OS, appliance applications and other files to operate an appliance. First boot loader module 71a is preferably capable of positioning updates so the secure OS is not accessible by any user and they will be installed as second software package 71d starts operation. Once installed, the primary OS operates the appliance, unless specially restarted in accordance with the invention. Special restarts enable a user of the appliance to involve the secure OS to perform desired operations.

Operation of first boot loader module 71a may also be controlled by the user to perform particular actions using a manual boot sequence. To illustrate, system 10 enables a first software package 71b to be positioned in the first of the plurality of partitions 51. Package 71b preferably includes a first boot loader module 71a, an installer system, and a secure OS preferably dedicated to running the installer system as provided herein. The installer system, upon initial startup of processing element 12, may install a second software package 71d. Second software package 71d preferably includes a primary OS, a second boot loader module 71c, the primary OS, and appliance application software. Processing element 12 uses the primary OS of package 71d instead of the secure OS of package 71b for normal operation. First boot loader module 71a in the software package 71b may be executed when the boot sequence of the system is first initiated, and system 10 may be customized with updates as desired by a manual boot sequence using the secure OS. These updates may be files on media such as external compact discs (CDs) or downloaded from a network such as the Internet.

Processing element 12 may, for example, be a network appliance such as a digital entertainment center with a single user entry point operable to process a plurality of media types, including music. Audio files such as MP3 or .WAV files may be played utilizing processing element 12 as a jukebox with an application such as a MP3 player or REALPLAYER, available from RealNetworks, Inc. To further illustrate, a network appliance such as a digital entertainment center includes a single user entry point 80 or interface, and is operable to process a plurality of media types, including music, “books on tape,” lectures, etc. Thus, if processing element 12 is a digital entertainment center, a user entry point 80 allows a consumer-user to perform functions such as, for example, automatically tracking and digitally recording selected music files, and to pause, rewind and instantly replay music programs much like a VCR records and plays back video cassettes. A user entry point 80 may be a GUI with functions such as those described above, or such as those presented with a word processing program such as Word, available from Microsoft Corporation. A user entry point 80 does not enable the consumer-user to access, change, or move files, beyond the extent permitted by the dedicated functions in user entry point 80. Processing element 12 may be one of a variety of appliances now known or developed in the future. For example, processing element 12 may be an appliance substantially similar to a VCR whose dedicated function is to allow a user to, for example, play, rewind and record video cassettes. The invention contemplates the development of new technologies that encompass today's traditional household appliances such as, but not limited to, ranges, refrigerators, televisions, and others, whether or not they include a substantial amount of electronic circuitry or logic, such as a stereo. These appliances may be operated by a user through a user entry point 80. Alternatively, processing element 12 may be a general- or a specific-purpose computer, and may even be a portion of a computer adapted to execute an OS. Processing element 12 may be a wireless device, such as a phone, personal digital assistant, or Internet appliance. The present invention contemplates a variety of other representative configurations, whether conventional or nonconventional, now known or that may be developed in the future.

Processing element 12 may include a variety of components that may be found in a representative processing device. Motherboard 14 includes a processor 20 coupled to a flash memory basic input/output system (BIOS) 16 and a random access memory (RAM) 18. BIOS 16 includes a power-on self-test module 17 for performing system initialization and tests. BIOS 16 is software code that is executed upon initialization or restart of processing element 12. Motherboard 14 also includes an interface chipset 22 for communicating with input-output devices such as, but not limited to, a mouse, a keyboard, a scanner, a printer, or a display device such as a monitor (not explicitly shown). In this embodiment, interface chipset 22 includes a parallel port 24, serial port 26, video port 27, and a universal serial bus (USB) 28 to communicate with the various input/output devices. Motherboard 14 also includes a flash memory 30. In a particular embodiment, flash memory 30 may be a serial flash memory coupled to interface chipset 22 via a System Management Bus (SMBus) 31.

Processing element 12 may be coupled to a variety of boot devices using a variety of interfaces for reading and/or storing data. For example, in the embodiment illustrated in FIG. 1, motherboard 14 may be coupled to one or more CD drives 42 via at least one integrated device electronics/advanced technology attachment packet interface (IDE/ATAPI) bus 52. CD drive 42 may be used to read or store data such as an OS and various other application modules or routines that may be used to boot Internet processing element 12 in certain scenarios. Motherboard 14 may also be coupled to one or more storage device 50 via busses 54, and to various other drive storage devices via respective busses 56 and 58. Such an advantage may allow processing element 12 to be used in a variety of applications, as desired. A boot device may be a storage medium such as a storage device 50, which provides very fast access to, and transfer of, data to processing element 12.

Processing element 12 may also be coupled to one or more networks such as the public switched telephone network (PSTN) that is accessible through a broadband connection such as a direct subscriber line (DSL) or cable modem, a dial-up connection, with a modem at a speed such as 56 K bps, a wireless network, an Ethernet network, or a network that conforms with the Home Phoneline Network Appliance (HomePNA) standard, which provides use of a plurality of applications using existing wiring in a location such as a home residence or other network now known or later developed. For simplicity, processing element 12 is illustrated in FIG. 1 as utilizing a network interface card (NIC) 71 coupled to chipset 22. NIC 71 may include one or more modems using a plurality of network protocols to couple, directly or indirectly, to Internet 70. As one example, NIC 71 may include dial-up, Ethernet, and HomePNA modems for accessing the Internet.

In the embodiment illustrated in FIG. 1, system 10 includes a storage device 50 that comprises a plurality of primary partitions 51 and 60. Storage device 50 may include a hard drive, whether removable or not, diskette, CD, memory sticks, or any other storage medium now known or later developed. In this embodiment, primary partitions 51 and 60 reside in storage device 50. As illustrated in FIG. 1, storage device 50 denotes an available amount of storage. Generally, partitions may be referred to as primary partitions and logical drives. On any storage device 50 there are preferably four primary partitions, the first of which is designated a standard partition that manages some or all of the available storage of the device on which the partition resides. The remaining partitions may be designated standard or extended partitions. Standard partitions manage some or all of the remaining storage of the device on which the partition resides. A partition that is designated an extended partition is the last primary partition on the device, and may manage the remaining or part of the remaining storage on the device. To access storage in an extended primary partition, a minimum of one logical partition must be designated inside the extended primary partition.

Generally, for processing element 12 to utilize storage device 50, master boot record 50a is located in the first block of storage device 50 in partition 5.1, and a secondary boot record 60a is located in the first block of partition 60, so that BIOS 16 may properly address boot sector information for each active partition. Master boot record 50a and secondary boot record 60a each includes a boot loader and partitioning layout for their respective partitions 51 and 60. Generally, standard primary partitions include a file system that the OS may access the OS, and any necessary applications. In some embodiments, some partitions may include database content that is organized by block addresses. On the other hand, generally extended primary partitions may contain logical drives, sufficient to manage all or part of the storage in that partition. The present invention contemplates locating boot loader 71a of package 71b in master boot record 50a, and boot loader 71c of package 71d in secondary boot record 60a. The remainder of package 71b may be stored in partition 51, and the remainder of package 71d may be stored in partition 61.

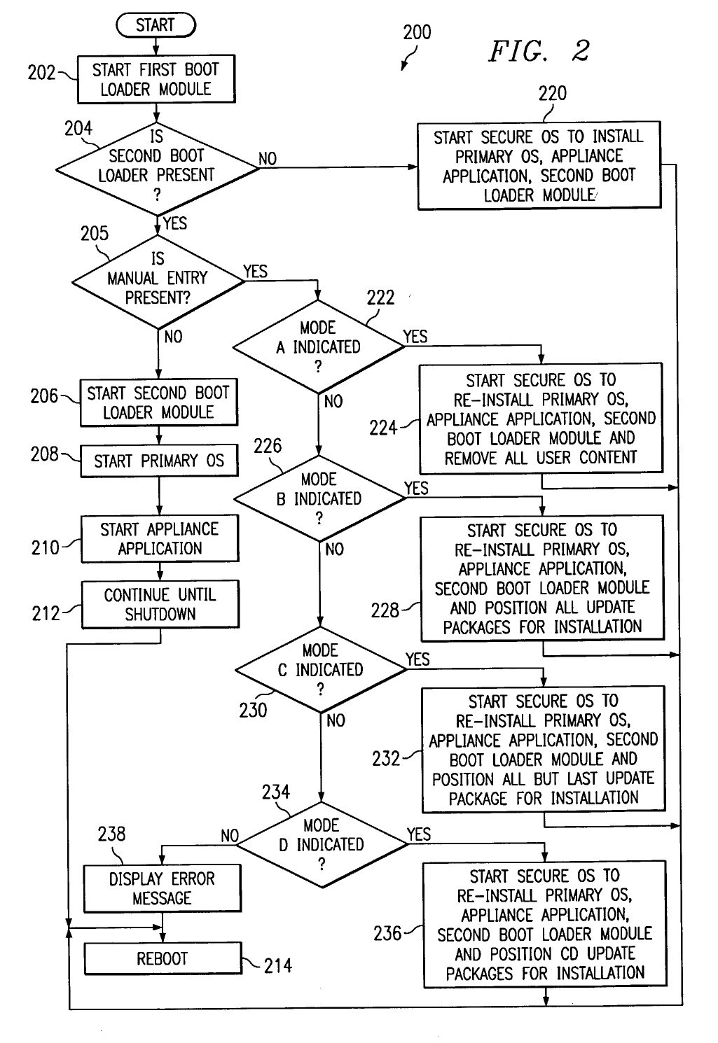

As illustrated in FIG. 1, partition 51 and partition 60 are the first and second of two primary partitions included in this embodiment. Each of partition 51 and 60 are isolated and operate as an independent unit with its own file system, because storage device 50 may not access any partition without instructions from software to execute a series of commands that are intended for a particular partition. The present invention contemplates installation and operation of at least two OSs on processing element 12. For example, primary OS executes an appliance application after all of the software has been initially loaded, or loaded upon restart, and assists other applications to execute, similarly to other OSs in accordance with a variety of known methods. The secure OS may, in a particular embodiment, include only those support tools necessary to perform installation of the second software package 71d, which include second boot loader module 71c, primary OS, appliance application, and all other files necessary to operate the appliance. The secure OS of first software package 71b is not accessible by any user, and may preferably only be invoked using first boot loader module 71a of first software package 71b upon initial start and any special restarts of processing element 12 in accordance with a method similar to the one discussed in detail in conjunction with FIG. 2.

Master boot record 50a may be stored on partition 51 and may be used to store first boot loader module 71a, and the remainder of package 71b, including the secure OS and the installer system, and other software, and data. In this embodiment, partition 60 may be used to store the remainder of data in storage device 50. This advantage protects boot loader module 71a and the secure OS of package 71b from being accessed and destroyed by any erroneous writes or other anomalies that usually occur when a system crashes.

In this embodiment, partition 60 is an extended partition. Partition 60 includes four logical partitions 61-64. Second software package 71d, which includes second boot loader module 71c, the primary OS, appliance application, and any other files to operate processing element 12, is installed on partition 61. This software that was installed on partition 61 may be used to install second boot loader module 71c into secondary boot record 60a. A mirror partition 63 may be used to mirror partition 61 for redundancy, to ensure the integrity of these files. Partition 62 may be used as a swap space of virtual memory, for a variety of reasons, including improved performance. Partition 64 may be used to store the remainder of data on storage device 50, including data content such as data files, audio and other media files.

The appliance applications that reside in partition 61 and 63 may be any application with which consumer-users interface while using processing element 12. In a particular embodiment, the appliance application may include a graphical user interface (GUI) as a user entry point. When, for example, processing element 12 is a network appliance such as a digital entertainment center, the appliance application allows playing, pausing, forwarding, and other typical functions for performing a music file, similar to those functions available for performing video files with video cassette recorder (VCR) appliances. Processing element 12 may also include remote control and front panel entry keys that provide input through any keyboard or user entry point 80 (not explicitly shown). The appliance application interprets these inputs into commands. In a particular embodiment, first boot loader module 71a installs this appliance application into the same partition with the primary OS. The appliance application may then utilize the primary OS to perform functions such as networking, file system operations, and display graphics.

It may be illustrative to discuss operation of the portions within packages 71b and 71d. Generally, boot loader modules are portions of executable software code designed to reside in a master boot record 50a or secondary boot record 60a of any primary partition of a storage medium, usually a hard drive. First and second boot loader modules of software packages 71b and 71d, respectively, are operable to start any OS or other boot loader modules that reside on the same storage device 50, whether or not these OS or other boot loader modules reside on the same partition of the storage medium. Execution of processor 20 is generally controlled upon retrieval of the first few blocks of a hard drive's active partition. Where these first few blocks contain an OS, processor 20 executes the OS. On the other hand, where the first few blocks contain a boot loader module, the boot loader module routes execution of processor 20 to an OS or another boot loader module, as desired. The installer system is executable software code that executes with the secure OS and includes more programs and/or scripts that may be used to load the primary OS and appliance application. Once it has been loaded, processing element 12 preferably does not enable external access to the installer system, which system is automatically installed in a predetermined configuration to perform a single task—to install the primary OS and appliance application in the designated partition.

First boot loader module 71a of software package 71b is preferably computer code used to route execution of processor 20 to secure OS of package 71b or to second boot loader module 71c of package 71d. Generally, in operation, BIOS 16 interfaces with storage device 50 and may execute one of two boot sequences as desired. For example, an automatic boot sequence may be used to initialize system 10 with boot loader module and secure OS of package 71b. A second manual boot sequence may be used to perform particular functions as desired by a user. These boot sequences may be performed using a method similar to one discussed in further detail in conjunction with FIG. 2.

FIG. 2 is an example of a method that may be used in a boot sequence to load software utilizing teachings of the present invention. Generally, the method includes installing first boot loader module 71a and secure OS of software package 71b into a particular partition. If second boot loader module 71c of package 71d is not yet present on any partition in storage device 50, then first boot loader module 71a will start the secure OS to ensure that the primary OS is installed in another partition in storage device 50. Where a user desires to perform manual startup functions, system 10 may be invoked by using external boot sequences. By way of example, a manual boot sequence may be provided by operating a user entry point 80 such as buttons or keys on a keyboard, remote control or chassis front panel (not explicitly shown). In this scenario, buttons on a user entry point 80 such as the remote control or front panel of processing element 12 may be operated in combination to externally invoke second boot loader module 71c of package 71d. Various embodiments may utilize fewer or more steps, and the method may be performed using a number of different implementations, depending on the application.

In step 202, BIOS 16 utilizes first boot loader module 71a to start up processing element 12. This start up may, for example, produce a parameter or other indicator, which denotes whether second boot loader module 71c of software package 71d is present in partition 60 of storage device 50 or whether a manual entry sequence is present. If, in step 204 second boot loader module 71c of software package 71d is present in partition 60 of storage device 50, the method proceeds to step 205. If, in step 205, no manual entry sequence is present, the method proceeds to step 206, where first boot loader module 71a passes control to second boot loader module 71c of package 71d. In step 208, second boot loader module 71c of package 71d invokes the primary OS under which processing element 12 is then operated. In step 210, the primary OS starts the appliance application, and the method then proceeds to continue in step 212 until shut down. The method proceeds to step 214 where processing element 12 is rebooted. Subsequent reboots under normal operation of processing element 12 will then utilize the primary OS associated with second boot loader module 71c of software package 71d, and not the secure OS, in accordance with the present invention. However, special restarts, as discussed and illustrated in conjunction with FIG. 2 as manual entry, invoke the secure OS to perform operations as desired.

If in step 204, second boot loader module 71c of package 71d is not present in partition 60 of storage device 50, and whether a manual entry sequence is present or not, the method proceeds to step 220, where first boot loader module 71a starts the secure OS, the installer system installs the primary OS, second boot loader module, appliance application, and other files of software package 71d necessary to operate processing element 12. In a particular embodiment, this installation is placed in partition 61, which may be used as a designated location from where processing element 12 may be booted, as discussed earlier in conjunction with FIG. 1. After the installation is complete, the method then proceeds to step 214 where processing element 12 is rebooted.

If, in step 205, a manual entry parameter or other indicator is present, the method then proceeds to query whether one of numerous key entries, or modes, has been entered in steps 222, 226, 230 and 234. In a particular embodiment, there are four modes A, B, C, and D. The invention contemplates numerous combinations for operations of keystrokes, buttons, or other invocation mechanisms to invoke a manual boot sequence. The invention also contemplates that numerous boot sequences may be used to perform a variety of activities.

In one example, if mode A is indicated in step 222, then a first sequence of key strokes may be used in step 224 for re-installing the primary OS, second boot loader module, and appliance application while eliminating all user content and updates. After this action, the method then proceeds to step 214 where processing element 12 is rebooted. If a mode A is not indicated in step 222, the method then proceeds to step 226, where if mode B is indicated, the method proceeds to step 228. In step 228, the method starts the secure OS for re-installing the primary OS, second boot loader, appliance application software, and positions all updates to be loaded on the first start of the primary O/S. After this action, the method then proceeds to step 214 where processing element 12 is rebooted. If mode B is not indicated in step 226, the method then proceeds to step 230, where if mode C is indicated, the method proceeds to step 232. In step 232, the method starts the secure OS for re-installing the primary OS, second boot loader module, appliance application software, and positions all updates except the last update to be loaded on the first start of the primary O/S. After this action, the method then proceeds to step 214 where processing element 12 is rebooted. If mode C is not indicated in step 230, the method then proceeds to step 234, where if mode D is indicated, the method proceeds to step 236. In step 236, the method starts the secure OS for re-installing the primary OS, second boot loader module, appliance application, and then positions update packages for installation using an external data source. As one example, the source may be a CD or other removable media mass storage device or downloadable software from a network such as the Internet. After this action, the method then proceeds to step 214 where processing element 12 is rebooted.

If mode D is not indicated in step 234, the method then proceeds to step 238, where the method displays an error message. This error message may be structured as desired, to indicate that no valid manual sequence has been entered. After this action, the method then proceeds to step 214 where processing element 12 is rebooted. The invention contemplates numerous methods for performing such automatic and manual boot sequences, depending on the implementation.

Embodiment of the present invention may provide the technical advantage of providing a stable and unchanging configuration for a permanent storage medium such as a hard disk drive. As another example, embodiments of the invention may provide the technical advantage of installing two independent OSs to be used in accordance with teachings of the present invention. This advantage provides software installed on a particular appliance that travels with the appliance. This installed software is now not as susceptible to being misplaced, forged, or corrupted, thereby improving the security of the system.

These advantages ensure a user that his system may be recovered without sending the appliance to a repair center should, for example, the hard drive be corrupted by a power outage or forced power down because it may be re-set or loaded to a state that is identical to that when tested at the manufacturer. This advantage also allows more effective and efficient troubleshooting, whether at the manufacturer or online or otherwise remote from the manufacturer. A user using this installed software may also ensure that the system may be recovered without sending the appliance to a repair center.

The invention contemplates performing steps in the method illustrated in FIG. 2 in various order, simultaneously, or omitting some of the steps. Furthermore, the present invention contemplates implementation of the method in software, hardware, or firmware. Any software is used may be computer-readable by a processor, whether or not local to processing element 12. That is, software may be distributed over one or more processing platforms.

What is claimed is:

1. A software loading method comprising:
providing a first software package on one of a plurality of primary partitions in a storage medium, the first software package comprising a first boot loader module, an installer system, and a secure operating system, the installer system operable to install a second software package, the second software package comprising a second boot loader module and a primary operating system, and an appliance application; and
automatically installing the second software package on a second of the plurality of primary partitions.

2. The method of claim 1, further comprising automatically booting the primary operating system upon re-start of an appliance coupled to the storage medium.

3. The method of claim 1, wherein said providing comprises providing a first software package on one of a plurality of primary partitions on a hard drive.

4. The method of claim 1, further comprising selectively invoking a boot sequence to be performed by the first software package.

5. The method of claim 4, wherein the boot sequence comprises one of the group consisting of installing all update packages to the appliance application, installing all update packages to the appliance application except a last update to the appliance application, erasing any existing user content on the storage medium, and installing all update packages to the appliance application using an external source operable to communicate with the storage medium.

6. The method of claim 1, wherein the second of the plurality of primary partitions comprises a plurality of logical partitions including a content partition, a system partition into which the second software package is installed, a second system partition available for system upgrades, and a swap space partition.

7. A software loading application, comprising:
a storage medium comprising a plurality of primary partitions; and
a first software package resident on one of the plurality of primary partitions, the first software package comprising a first boot loader module, an installer system and a secure operating system, the installer system operable to automatically install a second software package on a second of the plurality of primary partitions, the second software package comprising a second boot loader module, a primary operating system operable to be executed by a processor, and an appliance application.

8. The system of claim 7, wherein the boot loader module of the first software package is further operable to automatically boot the primary operating system upon re-start of an appliance coupled to the storage medium.

9. The system of claim 7, further comprising selectively invoking a boot sequence to be performed by the first software package.

10. The system of claim 9, wherein the boot sequence comprises one of the group consisting of installing all update packages to the appliance application, installing all update packages to the appliance application except a last update to the appliance application, erasing any existing user content on the storage medium, and installing all update packages to the appliance application using an external source operable to communicate with the storage medium.

11. The system of claim 7, wherein the second of the plurality of primary partitions comprises a plurality of logical partitions including a content partition, a system partition into which the second software package is installed, a second system partition available for system upgrades, and a swap space partition.

12. The system of claim 7, wherein the storage medium comprises a hard drive.

13. The system of claim 7, wherein the appliance comprises a digital entertainment center operable to couple to a network.

14. A software-loading method comprising:
providing a first software package on one of a plurality of primary partitions in a storage medium operatively associated with an appliance, the first software package comprising a first boot loader module, an installer system, and a secure operating system, the installer system operable to install a second software package, the second software package comprising a second boot loader module and a primary operating system, and an appliance application; and
automatically installing the second software package on a second of the plurality of primary partitions.

15. The method of claim 14, further comprising automatically booting the primary operating system upon re-start of the appliance.

16. The method of claim 14, wherein said providing comprises providing a first software package on one of a plurality of primary partitions on a hard drive.

17. The method of claim 14, further comprising selectively invoking a boot sequence to be performed by the first software package.

18. The method of claim 17, wherein the boot sequence comprises one of the group consisting of installing all update packages to the appliance application, installing all update packages to the appliance application except a last update to the appliance application, erasing any existing user content on the storage medium, and installing all update packages to the appliance application using an external source operable to communicate with the storage medium.

19. The method of claim 14, wherein the second of the plurality of primary partitions comprises a plurality of logical partitions including a content partition, a system partition into which the second software package is installed, a second system partition available for system upgrades, and a swap space partition.

20. A software loading system, comprising:
a storage medium comprising a plurality of primary partitions;
an appliance operatively associated with the storage medium; and
a first software package resident on one of the plurality of primary partitions, the first software package comprising a first boot loader module, an installer system and a secure operating system, the installer system operable to automatically install a second software package on a second of the plurality of primary partitions, the second software package comprising a second boot loader module, a primary operating system operable to be executed by a processor, and an appliance application.

21. The system of claim 20, wherein the boot loader module of the first software package is further operable to automatically boot the primary operating system upon re-start of an appliance coupled to the storage medium.
